(19) United States
(12) Patent Application Publication
(10) Pub. No.: US 2022/0122320 A1
(43) Pub. Date: Apr. 21, 2022

(54) MACHINE-LEARNING INTEGRATION FOR 3D RESERVOIR VISUALIZATION BASED ON INFORMATION FROM MULTIPLE WELLS

(71) Applicant: Halliburton Energy Services, Inc., Houston, TX (US)

(72) Inventors: Hsu-Hsiang Wu, Sugar Land, TX (US); Michael S. Bittar, Houston, TX (US); Weixin Dong, Sugar Land, TX (US)

(21) Appl. No.: 17/073,008

(22) Filed: Oct. 16, 2020

(51) Int. Cl. G06T 17/05; G06T 17/20; G06N 20/00

(52) U.S. Cl. CPC G06T 17/05; G06N 20/00; G06T 17/20

(57) ABSTRACT

Methods and systems for determining 3D properties of a formation are provided. The method includes acquiring inversion results from two or more wellbores and transforming the inversion results into first 3D mesh properties, wherein the first 3D mesh properties represent one or more geological features of a formation surrounding each wellbore of the two or more wellbores within a defined range from each of the wellbores, where the one or more geological features are correlated to a 3D coordinate system. The method further includes determining, using a machine learning algorithm, one or more similar geological features among the two or more wellbores based on the first 3D mesh properties; interpolating second 3D mesh properties based on the one or more similar geological features, wherein the second 3D mesh properties are properties of the formation outside the defined range; and integrating the first 3D mesh properties and the second 3D mesh properties to acquire final 3D mesh properties.

### TECHNICAL FIELD

The disclosure generally relates to the field of determining characteristics of a reservoir in an earth formation and visualization thereof. The visualization can be aided with machine learning.

### BACKGROUND

In drilling wells for oil and gas exploration, understanding the structure and properties of the associated geological formation provides information beneficial to such exploration. The collection of information relating to formation properties and conditions downhole is commonly referred to as “logging,” and can be performed during the drilling process or after a wellbore is drilled.

Various measurement tools, such as those used wireline logging, logging while drilling (LWD), and measurement while drilling (MWD), can be used to take measurements of the formation. At times, more than one wellbore is drilled in the same wellbore and measurements of the formation are taken from each wellbore.

### BRIEF DESCRIPTION OF THE DRAWINGS

Embodiments of the disclosure may be better understood by referencing the accompanying drawings.

FIG. 1 illustrates a schematic diagram of a well measurement system, according to one or more embodiments.

FIG. 2 illustrates a schematic diagram of a drilling system for well measurement, according to one or more embodiments.

FIG. 3 is a flow chart depicting an example of a method for three-dimensional (3D) visualization of a reservoir, according to one or more embodiments.

FIG. 4A depicts a two-dimensional (2D) visualization of the inversion results based on 1D inversion results, according to one or more embodiments.

FIG. 4B depicts two three-dimensional (3D) visualizations of the inversion results, according to one or more embodiments.

FIG. 5 depicts the two or more wellbores having inversion results acquired for each wellbore, according to one or more embodiments.

FIG. 6 depicts a cross-plane visualization for the inversion results in a TVD-North plane for the two or more wellbores, according to one or more embodiments.

FIG. 7 depicts the cross-plane visualization of the inversion results with interpolation results between the two or more wellbores, according to one or more embodiments.

FIG. 8 depicts a cross-plane visualization of integrated inversion results among the two or more wellbores, according to one or more embodiments.

### DESCRIPTION

Downhole measurements, such as those taken with deep and/or ultra-deep electromagnetic measurements, enable gathering information about a subterranean formation in a defined range, e.g., from 100 to 300 feet (ft), from a drilled, or being drilled, wellbore. This gathered information within the defined range can be represented as first 3D mesh properties. When multiple wellbores are drilled in the same subterranean formation, e.g., from the same pad, second 3D mesh properties between the wellbores, including outside the defined range, can be interpolated. The first and second 3D mesh properties can be integrated to determine final 3D mesh properties representing substantial portions of a subterranean formation. These final 3D mesh properties can be visualized into a 3D reservoir model of the subterranean formation.

Determining 3D mesh properties of a subterranean formation beyond the defined range of a tool in an individual wellbore allows operations to plan a better geosteering strategy for any future wellbore design in the same pad and/or formation. It also can provide improved geology information about a reservoir and more accurate production estimation from the pad and/or reservoir.

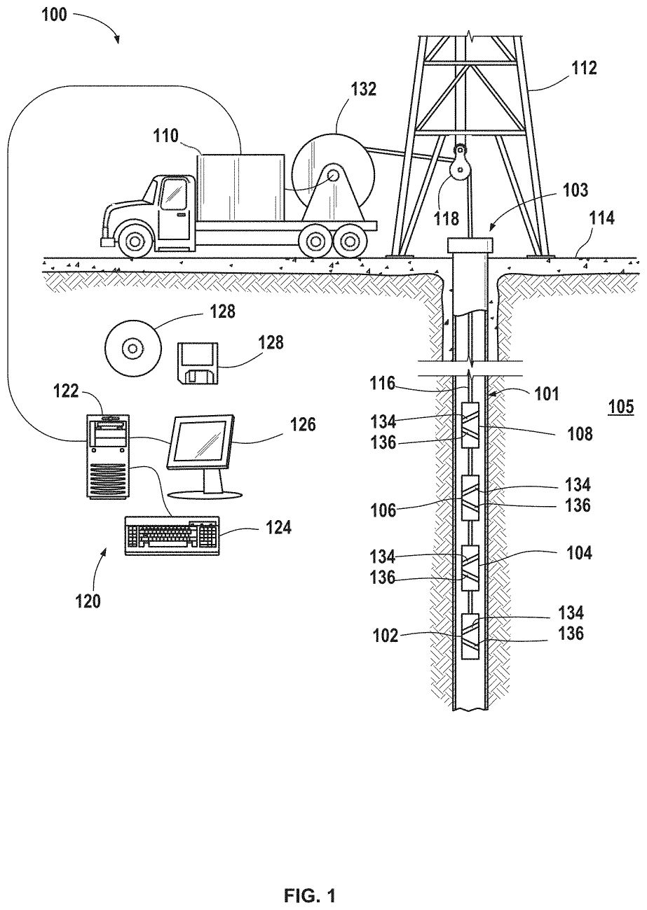

FIG. 1 illustrates a schematic diagram of a well measurement system 100, according to one or more embodiments. In one or more embodiments, the well measurement system can be an electromagnetic (EM) well measurements system. However, other well measurements systems or combinations thereof are possible, e.g., nuclear magnetic resonance, acoustic, seismic, pulse neutron, or the like. For example, EM measurements could be taken via a first wellbore and seismic measurements could be taken via a second wellbore. As illustrated, a wellbore 101 may extend from a wellhead 103 into a subterranean formation 105 from surface 114. Generally, the wellbore 101 may include horizontal, vertical, slanted, curved, and other types of wellbore geometries and orientations. The wellbore 101 may be cased (as shown), partially cased (i.e., cased to a certain depth), or uncased. In one or more embodiments, the wellbore 101 may include a metallic material. By way of example, the metallic member may be a casing, liner, tubing, or other elongated steel tubular disposed in the wellbore 101.

As illustrated in FIG. 1, the wellbore 101 may extending generally vertically into the subterranean formation 105, however (although not shown) wellbore 101 may extend at an angle through subterranean formation 105, such as horizontal and slanted wellbores. For example, although FIG. 1 illustrates a vertical or low inclination angle well, high inclination angle or horizontal placement of the well and equipment may be possible. It should further be noted that while FIG. 1 generally depicts a land-based operation, the principles described herein are equally applicable to subsea operations that employ floating or sea-based platforms and rigs, without departing from the scope of the disclosure.

Well measurement system 100 may include one or more downhole tools disposed on a conveyance 116, which may be lowered into wellbore 101. For example, well measurement system 100 is depicted with four downhole tools, a first downhole tool 102, a second downhole tool 104, a third downhole tool 106, and/or a fourth downhole tool 108. While for downhole tools are shown, there may be as few as one downhole tool or more than four downhole tools. In one or more embodiments, each downhole tool may be separated by about 1 foot (about 0.3 meters (m)) to about 100 ft (30 m), about 20 ft (about 6.1 m) to about 200 ft (about 61 m), or about 50 ft (about 15 m) to about 100 ft (about 30 m). As illustrated, the first downhole tool 102, the second downhole tool 104, the third downhole tool 106, and/or the fourth downhole tool 108 are attached to a vehicle 110 via a drum 132. However, in one or more embodiments, it should be noted that the downhole tools 102, 104, 106, 108 may not be attached to a vehicle 110. The conveyance 116 and the downhole tools 102, 104, 106, 108 may be supported by a rig 112 at the surface 114.

The downhole tools 102, 104, 106, 108 may be tethered to vehicle 110 through conveyance 116. Conveyance 116 may be disposed around one or more sheave wheels 118 to vehicle 110. Conveyance 116 may include any suitable means for providing mechanical conveyance for the downhole tools 102, 104, 106, 108, including, but not limited to, wireline, slickline, coiled tubing, pipe, drill pipe, downhole tractor, or the like. In some embodiments, conveyance 116 may provide mechanical suspension as well as electrical connectivity for the downhole tools 102, 104, 106, 108. For example, conveyance 116 may include, in some instances, one or more electrical conductors extending from vehicle 110 that may be used for communicating power and telemetry between vehicle 110 and the downhole tools 102, 104, 106, 108.

Information from first downhole tool 102, second downhole tool 104, third downhole tool 106, and/or fourth downhole tool 108 may be gathered and/or processed by information handling system 120. For example, signals recorded by first downhole tool 102, second downhole tool 104, third downhole tool 106, and/or fourth downhole tool 108 may be stored on memory and then processed by the information handling system 120. The processing may be performed real-time during data acquisition or after recovery of first downhole tool 102, second downhole tool 104, third downhole tool 106, and/or fourth downhole tool 108. Processing may occur downhole, at the surface, or may occur both downhole and at surface. In some embodiments, signals recorded by first downhole tool 102, second downhole tool 104, third downhole tool 106, and/or fourth downhole tool 108 may be conducted to the information handling system 120 by way of conveyance 116. The information handling system 120 may process the signals and the information contained therein may be displayed, and/or visualized, for an operator to observe and stored for future processing and reference. The information handling system 120 may also contain an apparatus for supplying control signals and power to the downhole tools 102, 104, 106, 108.

Systems and methods of the present disclosure may be implemented, at least in part, with the information handling system 120. The information handling system 120 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, the information handling system 120 may be a personal computer, a network storage device, or any other suitable device and may vary in size, shape, performance, functionality, and price. The information handling system 120 may include random access memory (RAM), one or more processing resources such as a central processing unit (CPU) 122 or hardware or software control logic, ROM, and/or other types of nonvolatile memory. Additional components of the information handling system 120 may include one or more disk drives, one or more network ports for communication with external devices as well as an input device 124 (e.g., keyboard, mouse, etc.) and output devices, such as a display 126. The information handling system 120 may also include one or more buses operable to transmit communications between the various hardware components. Although not shown, the information handling system 120 may include one or more network interfaces. For example, the information handling system 120 can communicate via transmissions to and/or from remote devices via the network interface 1005 in accordance with a network protocol corresponding to the type of network interface, whether wired or wireless and depending upon the carrying medium. In addition, a communication or transmission can involve other layers of a communication protocol and or communication protocol suites (e.g., transmission control protocol, Internet Protocol, user datagram protocol, virtual private network protocols, etc.).

Alternatively, systems and methods of the present disclosure may be implemented, at least in part, with non-transitory computer-readable, or machine-readable, media 128. Non-transitory computer-readable media 128 may include any instrumentality or aggregation of instrumentalities that may retain data and/or instructions for a period of time. Non-transitory computer-readable media may include, for example, but not limited to, a system, apparatus, or device, that employs any one of or combination of electronic, magnetic, optical, electromagnetic, infrared, or semiconductor technology to store program code. Non-transitory computer-readable media 128 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other EM and/or optical carriers; and/or any combination of the foregoing. In the context of this document, a computer-readable storage medium may be any tangible medium that can contain or store a program for use by or in connection with an instruction execution system, apparatus, or device. For example, the computer-readable storage medium can comprise program code executable by a processor to cause the processor to perform one or more steps. The computer-readable storage medium can further comprise program code executable by the process to cause the one or more downhole tools to perform a function, e.g., transmitting a signal, receiving a signal, and/or taking one or more measurements.

A computer-readable storage medium is not a machine-readable signal medium. A machine-readable signal medium may include a propagated data signal with machine-readable program code embodied therein, for example, in baseband or as part of a carrier wave. Such a propagated signal may take any of a variety of forms, including, but not limited to, electromagnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on computer-readable media 128 may be transmitted using any appropriate medium, including but not limited to wireless, wireline, optical fiber cable, radio frequency (RF), etc., or any suitable combination of the foregoing. Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and procedural programming languages, such as the “C” programming language or similar programming languages. The program code may execute entirely on a stand-alone machine, may execute in a distributed manner across multiple machines, and may execute on one machine while providing results and or accepting input on another machine. The program code/instructions may also be stored in a machine-readable medium that can direct a machine to function in a particular manner, such that the instructions stored in the computer-readable storage medium produce an article of manufacture including instructions which implement the function/act specified in the flowchart and/or block diagram block or blocks.

In one or more embodiments, first downhole tool 102, second downhole tool 104, third downhole tool 106, and/or fourth downhole tool 108 may each include a transmitter 134 and/or a receiver 136. It should be noted each downhole tool may include a plurality of transmitters 134 and/or a plurality of receivers 136. The transmitter 134 and the receiver 136 may be disposed along a longitudinal axis of any downhole tool. As disclosed, the concepts that are described herein are valid for any type of transmitters 134 and receiver 136. As an example, wire antenna, toroidal antenna and/or azimuthal button electrodes, transmitter coils, and/or receiver coils may also be used in the place of the transmitters 134 and/or the receiver 136. In some examples, the receiver 136 may be or include both a transmitter and a receiver, i.e., a transceiver. Without limitation, the transmitters 134 and/or the receiver 136 may be disposed on and/or adjacent to a gap sub. In one or more embodiments, the transmitters 134 and/or the receiver 136 may be disposed on and/or adjacent to more than one gap sub.

Additionally, in one or more embodiments, the transmitter 134 operate and function to broadcast an EM field. In one or more embodiments, the transmitter 134 may broadcast (i.e., generate) a low frequency EM field and/or a high frequency EM field. A “low frequency” can range from about 1 KHz to about 250 KHz, and a “high frequency” can be defined to range from about 250 KHz to about 2 MHz. Although defined as high and low, other frequency band descriptions between 1 KHz and 2 MHz are possible. The transmitter 134 may broadcast the high frequency EM field and the low frequency EM field on any number of frequencies along any number of channels sequentially and/or simultaneously on the same antenna and/or multiple antennas. In one or more embodiments, first downhole tool 102, second downhole tool 104, third downhole tool 106, and/or fourth downhole tool 108 may operate with additional equipment (not illustrated) on surface 114 and/or disposed in a separate EM well measurement system (not illustrated) to record, i.e., take, measurements and/or values from the subterranean formation 105. During operations, the transmitter 134 may broadcast the high frequency EM field or the low frequency EM field from first downhole tool 102, second downhole tool 104, third downhole tool 106, and/or fourth downhole tool 108. The transmitter 134 may be connected to the information handling system 120, which may further control the function and/or operation of transmitter 134. Additionally, receiver 136 can measure and/or record EM fields broadcasted from transmitter 134, i.e., taking one or more EM measurements of the formation 105. For example, the receiver 136 can record voltages from the EM fields induces by the transmitter 134. The receiver 136 may transfer recorded information to the information handling system 120. The information handling system 120 can control the operation of receiver 136. For example, the broadcasted EM field from transmitter 134 may be altered (i.e., in phase and attenuation, and/or the like) by the formation 105, which may be sensed, measured, and/or recorded by receiver 136, i.e., receiver 136 takes one or more EM measurements of the formation. The measurements can be based on the low frequency magnetic field broadcasted by transmitter 134, corresponding to “deep” EM measurements, and/or based on the high frequency magnetic field broadcasted by transmitter 134, corresponding to “shallow” EM measurements. Without limitations, deep EM measurements are measurements that may be able to measure formation properties that are more than 100 ft (more than about 30 m) away from the receiver 136. Shallow EM measurements are measurements that are sensitive to formation properties within a range of, i.e., less than or equal to, about 100 ft (with a range of about 30 m) away from the receiver 136. It should be noted that transmitter 134 and receiver 136 may be the same antenna, coil, toroid, and/or the like. The recorded signal may be transferred to the information handling system 120 for further processing.

In one or more embodiments, there may be any suitable number of transmitters 134 and/or receivers 136, which may be controlled the by information handling system 120. Information and/or measurements may be processed further by the information handling system 120 to determine properties of the wellbore 101, fluids disposed therein, and/or the formation 105.

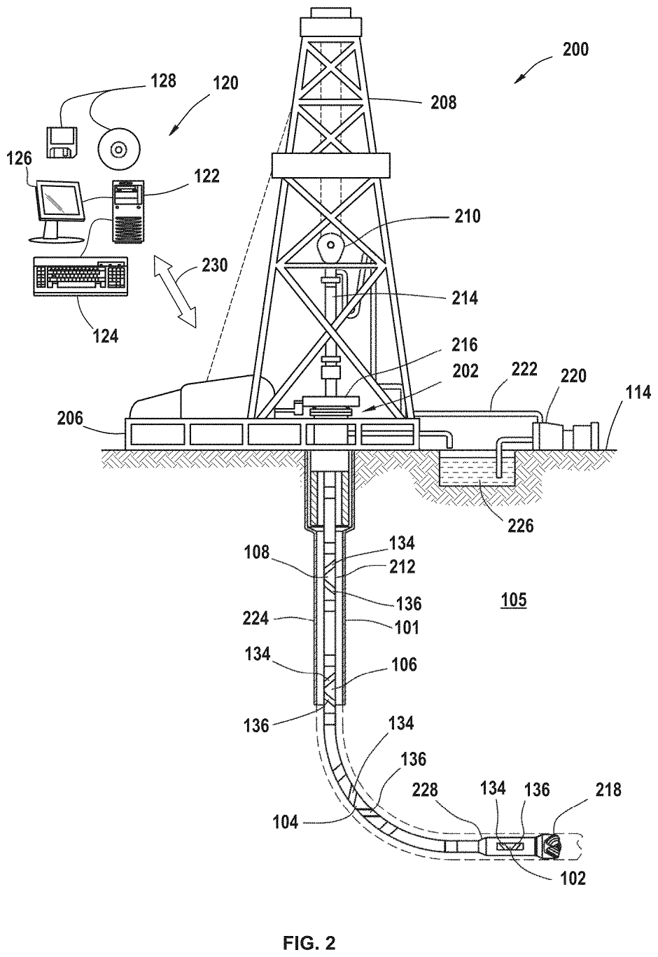

FIG. 2 illustrates a schematic diagram of a drilling system 200 for well measurement, according to one or more embodiments. As illustrated, the first downhole tool 102, the second downhole tool 104, the third downhole tool 106, and/or the fourth downhole tool 108 are disposed in wellbore 101 via the drilling system 200. The drilling system 200 includes a drilling platform 206 that supports a derrick 208 having a traveling block 210 for raising and lowering drill string 212. Drill string 212 may include, but is not limited to, drill pipe and coiled tubing, as generally known to those skilled in the art. A kelly 214 may support the drill string 212 as it may be lowered through a rotary table 216. A drill bit 218 may be attached to the distal end of the drill string 212 and may be driven either by a downhole motor and/or via rotation of drill string 212 from surface 114. Without limitation, the drill bit 218 may include, roller cone bits, PDC bits, natural diamond bits, any hole openers, reamers, coring bits, and the like. As the drill bit 218 rotates, it may create and extend wellbore 101 that penetrates the subterranean formation 105. A pump 220 may circulate drilling fluid through a feed pipe 222 to kelly 214, downhole through interior of drill string 212, through orifices in drill bit 218, back to surface 114 via annulus 224 surrounding drill string 212, and into a retention pit 226.

With continued reference to FIG. 2, drill string 212 may begin at wellhead 202 and may traverse wellbore 101. The drill bit 218 may be attached to a distal end of the drill string 212 and may be driven, for example, either by a downhole motor and/or via rotation of the drill string 212 from surface 114. Drill bit 218 may be a part of bottom hole assembly (BHA) 228 at distal end of drill string 212. In one or more embodiments, the BHA 228 may further include the first downhole tool 102. The first downhole tool 102 may be disposed on the outside and/or within the BHA 228. In one or more embodiments, the second downhole tool 104, the third downhole tool 106, and/or the fourth downhole tool 108 are disposed on drill string 212. The second downhole tool 104, the third downhole tool 106, and/or the fourth downhole tool 108 may be disposed on the outside and/or within the drill string 212. The first downhole tool 102, the second downhole tool 104, the third downhole tool 106, and/or the fourth downhole tool 108 may include the transmitter 134 and/or the receiver 136, as described previously with respect to FIG. 1. As with FIG. 1, the first downhole tool 102, the second downhole tool 104, the third downhole tool 106, and/or the fourth downhole tool 108 may include a plurality of transmitters 134 and/or receivers 136. The transmitters 134 and/or receivers 136 may operate and/or function as described above. As will be appreciated by those of ordinary skill in the art, the first downhole tool 102, the second downhole tool 104, the third downhole tool 106, and/or the fourth downhole tool 108 may be used as part of a measurement-while drilling (MWD) or logging-while-drilling (LWD) system.

Without limitation, the first downhole tool 102, the second downhole tool 104, the third downhole tool 106, and/or the fourth downhole tool 108, the transmitters 134, and/or the receiver 136 may be connected to and/or controlled by the information handling system 120. The information handling system 120 may be disposed at the surface 114 or downhole, and thus processing of information recorded may occur downhole and/or on surface 114. Processing occurring downhole may be transmitted to surface 114 to be recorded, observed, and/or further analyzed. Additionally, information recorded on the information handling system 120 that may be disposed downhole may be stored until the first downhole tool 102, the second downhole tool 104, the third downhole tool 106, and/or the fourth downhole tool 108 are brought to surface 114.

In one or more embodiments, the information handling system 120 may communicate with first downhole tool 102, second downhole tool 104, third downhole tool 106, and/or fourth downhole tool 108 through a communication line (not illustrated) disposed in (or on) drill string 212. In one or more embodiments, wireless communication may be used to transmit information back and forth between the information handling system 120 and at least one of the downhole tools 102, 104, 106, 108. The information handling system 120 may transmit information to the downhole tools 102, 104, 106, 108 and may receive as well as process information recorded by the downhole tools 102, 104, 106, 108. In one or more embodiments, a downhole information handling system (not illustrated) may include, without limitation, a microprocessor or other suitable circuitry, for estimating, receiving and processing signals from first downhole tool 102, second downhole tool 104, third downhole tool 106, and/or fourth downhole tool 108. Downhole information handling system (not illustrated) may further include additional components, such as memory, input/output devices, interfaces, and the like. In one or more embodiments, while not illustrated, the first downhole tool 102, the second downhole tool 104, the third downhole tool 106, and/or the fourth downhole tool 108 may include one or more additional components, such as analog-to-digital converter, filter and amplifier, among others, that may be used to process the measurements of the first downhole tool 102, the second downhole tool 104, the third downhole tool 106, and/or the fourth downhole tool 108 before they may be transmitted to the surface 114. Alternatively, raw measurements from the first downhole tool 102, the second downhole tool 104, the third downhole tool 106, and/or the fourth downhole tool 108 may be transmitted to surface 114.

Any suitable technique may be used for transmitting signals from first the downhole tool 102, the second downhole tool 104, the third downhole tool 106, and/or the fourth downhole tool 108 to the surface 114, including, but not limited to, wired pipe telemetry, mud-pulse telemetry, acoustic telemetry, and EM telemetry. While not illustrated, the first downhole tool 102, the second downhole tool 104, the third downhole tool 106, and/or the fourth downhole tool 108 may include a telemetry subassembly that may transmit telemetry data to the surface 114. Without limitation, an EM source in the telemetry subassembly may be operable to generate pressure pulses in the drilling fluid that propagate along the fluid stream to the surface 114. At the surface 114, pressure transducers (not shown) may convert the pressure signal into electrical signals for a digitizer (not illustrated). The digitizer may supply a digital form of the telemetry signals to the information handling system 120 via a communication link 230, which may be a wired or wireless link. The telemetry data may be analyzed and processed by the information handling system 120. In addition to, or in place of, processing at the surface 114, processing may occur downhole.

As in the system 100, the first downhole tool 102, the second downhole tool 104, the third downhole tool 106, and/or the fourth downhole tool 108 may each include one or more transmitters 134 and/or one or more receivers 136. In one or more embodiments, the first downhole tool 102, the second downhole tool 104, the third downhole tool 106, and/or the fourth downhole tool 108 may operate with additional equipment (not illustrated) on the surface 114 and/or disposed in a separate well measurement system (not illustrated) to record measurements and/or values from the subterranean formation 105. During operations, each transmitter 134 and receiver 136 functions as described in FIG. 1.

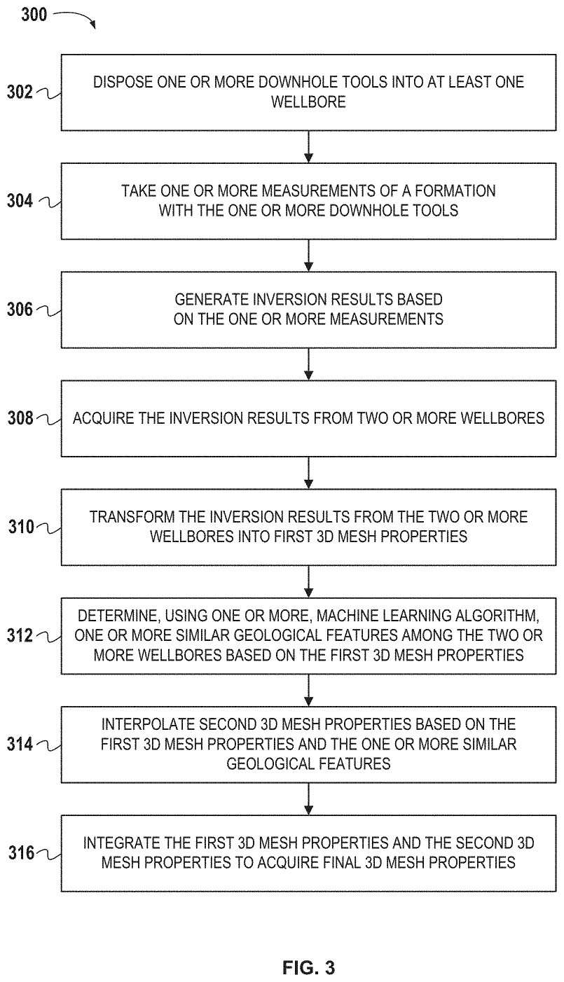

FIG. 3 is a flow chart depicting an example of a method 300 for 3D visualization of a reservoir, according to one or more embodiments. The method (or processes or operations) are described as being performed by well measurement system 100 or drilling system 200 depicted in FIGS. 1 and 2, for consistency with the earlier description. For example, the 3D visualization of a reservoir can be transmitted to the information handling system 120 and shown on the display 126, stored, or printed on a physical medium.

At 302, one or more downhole tools (e.g., at least one of downhole tools 102, 104, 106, or 108) is disposed into at least one wellbore. The at least one wellbore can be a group of wellbores, e.g., two or more wellbores, drilled in the same reservoir or formation. A reservoir is a system of producible hydrocarbons (e.g., oil, gas, or the like) contained in the subterranean formation 105. For example, the two or more wellbores can be drilled from the same pad. In another, example the two or more wellbores can be drilled from more than one pad. “Pad” as used herein refers to a location at the surface 114 which houses the wellheads for a number of drilled, or being drilled, wellbores. In one or more embodiments, the two or more wellbores drilled from a pad or group of pads are drilled in the same reservoir. The downhole tools can be disposed in the at least one wellbore as part of the well measurements system 100, e.g., in an already drilled wellbore or can be part of the drilling system 200, e.g., in LWD or MWD system.

At 304, according to one or more embodiments, the one or more downhole tools take one or more measurements of the subterranean formation 105. For example, the transmitter 134 and receiver 136 of each downhole tool can operated to take one or more measurements of the subterranean formation 105. In one or more embodiments, the measurements are taken in each of the two or more wellbores. For example, measurements can be taken in two, three, four, or more different wellbores drilled in the same formation or reservoir.

The measurements can be divided into at least two sets of measurements, “deep” measurements and “shallow” measurements. In one or more embodiments, the deep measurements are deep EM measurements and the shallow measurements are shallow EM measurements. The deep EM measurements are acquired via the low frequency EM field(s) generated by the transmitter 134, and the shallow EM measurements are acquired via the high frequency EM field(s) generated by the transmitter 134. For deep EM measurements, a low frequency signal may be used to obtain a depth of investigation (DOI) that may be more about 100 ft (30 m) to about 500 ft (about 152 m). A long spacing between a transmitter 134 of a first downhole tool of the system (e.g., part of downhole tool 108 in FIG. 1 or 2) and a receiver 136 of the furthest downhole tool of the system (e.g., part of downhole tool 102 in FIG. 1 or 2) may be from about 20 ft (about 6 m) to about 200 ft (about 61 m). For shallow EM measurements, a high frequency signal may be used with a DOI that may be shorter, e.g., from about 1 foot (about 0.3 m) to about 100 ft (about 30 m). Shallow EM measurements can be via short spaced receivers and transmitters, e.g., spacing between a transmitter 134 and a receiver 136 (e.g., referring to FIGS. 1-2) ranging from about 1 foot (0.3 m) to about 20 ft (6 m). For example, shallow EM measurements can be obtained with a single downhole tool (e.g., only one of downhole tools 102, 104, 106, or 108). Different of combinations of transmitters and receivers among the downhole tools of the system allows for varying DOI along each wellbore. The maximum extent of the DOI is the “defined range” or “detection range” of the measurements of a tool string disposed in a single wellbore.

The measurements can be taken continuously or at least at continuous measured depths of the wellbore. For example, as the downhole tool(s) advance through the wellbore from the surface, measurements can be taken continuously along the wellbore or can be taken whenever the tool moves further in depth (as at times progress along the wellbore is halted) to provide continuous measurements along the measured depth of the wellbore. In one or more embodiments, measurements are not continuous or are semi-continuous yet still can be adjacent measurements, i.e., the measurements can occur at adjacent discrete depths along the measured depth of the well bore (thus described as “adjacent measurements”). In one or more embodiments, the one or more measurements are both continuous and adjacent, e.g., one or more continuous and adjacent EM measurements.

Measured depth as used herein refers to the axial measurement along a length of wellbore and can have a vertical depth component and horizontal depth components. This can be described in a XYZ plane or any three-dimensional coordinate system. In one or more embodiments, a TVD-N-E plane is used to describe the measured depth, where “TVD” is true vertical depth (i.e., a measurement from the surface to the bottom of the borehole or anywhere along its length in a straight line), N is magnetic north or “earth north”, and E is east. In an angled borehole, e.g., a horizontal wellbore, TVD is shorter than measured depth.

At 306, inversion results are generated based on the one or more measurements, e.g., EM measurements, nuclear magnetic resonance (NMR) measurements, acoustic measurements, pulse neutron measurements, or the like. In one or more embodiments, inversion results are generated based on the one or more measurements in two or more wellbores. The inversion results can be based on 1D, 2D, and/or 3D inversions.

In one or more embodiments, the inversion may be a general inversion which uses minimization algorithms to find a formation model that may fit the measurements. In one or more embodiments, the inversion can assume a 1D layered model within a designated area or range above and below each wellbore defined by the DOI, which is proportional to tool spacing (as described above).

In one or more embodiments, a multi-step inversion may be implemented to preserve high resolution near each wellbore while being able to detect boundaries of the formation at a distance. For example, in the multi-step inversion the shallow measurement may be inverted, and the results may be fed into a second inversion using deep measurements to find a formation resistivity model. This inversion scheme may be updated when an operator selects initials guesses based on the previous inversion results to improve quality of the formation resistivity model. For example, machine learning may be utilized to identify the similarities among inversion solutions as well as to train the information handling system 120 (e.g., referring to FIGS. 1 and 2) to recognize a model that may fit all solutions. Color and/or greyscale visualization may be used to present inversion results (i.e., the formation resistivity profiles) surrounding the first downhole tool 102, the second downhole tool 104, the third downhole tool 106, and/or the fourth downhole tool 108. But different color scale (or greyscale) ranges on overall inversion results may present different geological information and emphasis on different geological structures at different locations. Therefore, recalculating the similarities among all inverted results using different color scale (or greyscale) range may train the information handling system 120 to identify a best model or a reliable model. A guide-model inversion may be also implemented to further train the information handling system 120.

In one or more embodiments, the inversion can be 1D, 2D or 3D inversion which is based on different formation model assumptions. The inversion can also be stochastic inversion that is a statistical process to generate a range of possible model realizations for best fit against various measurements.

At 308, the inversion results are acquired from the two or more wellbores. For example, a first set of inversion results can be acquired from a first wellbore of the two or more wellbores and a second set of inversion results can be acquired from a second wellbore of the two or more wellbores. Third, fourth, or fifth sets of inversion results, etc. can be acquired similarly from third, fourth, or fifth wellbores of the two or more wellbores. In one or more embodiments, a plurality sets of inversion results can be acquired from as plurality of wellbores drilled in the same formation and/or reservoir. The inversion results can include any and/or all of the sets of inversion results from the two or more wellbores.

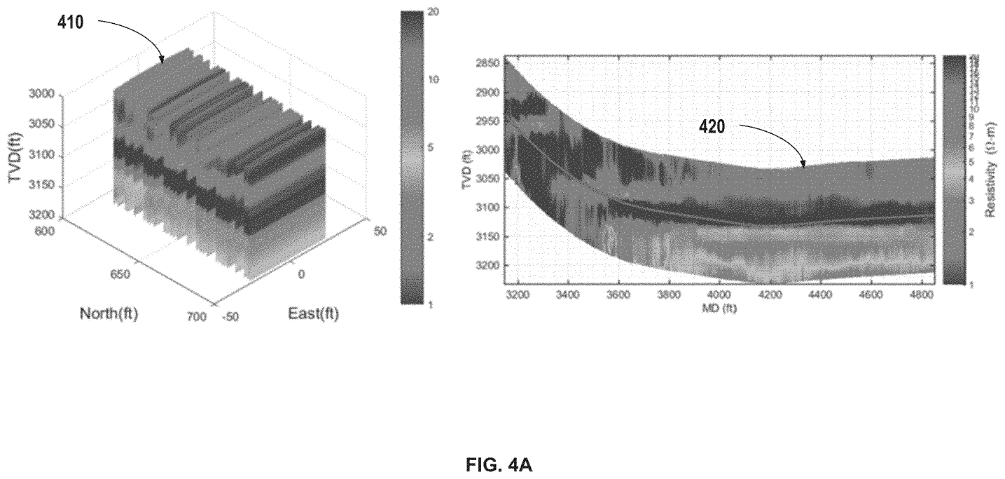

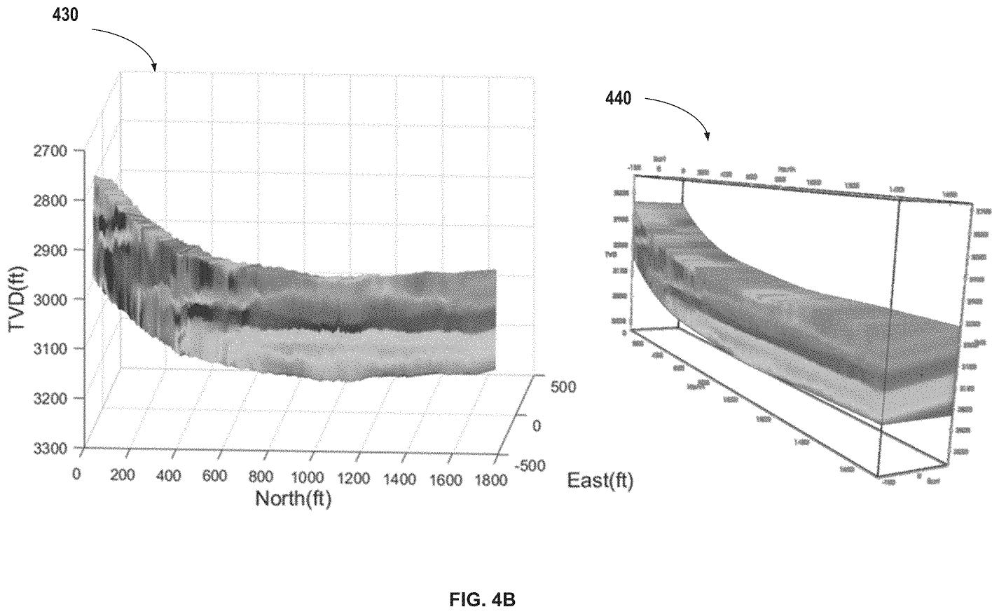

In one or more embodiments, the inversion results for each wellbore can be visualized, e.g., using 1D, 2D, or 3D visualization. For example, FIG. 4A depicts a two-dimensional (2D) visualization 420 of the inversion results based on 1D inversion results 410, according to one or more embodiments. Both the 2D visualization 420 and the 1D inversion results 410 depict varying resistivity in Ohm-meters (Ω-m) based on a color scale or gray scale (as shown). The 1D inversion results 410 are mapped in a TVD-North-East space, whereas the 2D inversion results are mapped in a TVD—Measured Depth (MD) plane, all shown in units of feet (ft). The 1D inversion results 410 can be point-by-point 1D inversion results. The 1D inversion can be based on a local coordinate system, where each measured depth could have a different definition of the local coordinate systems. Continuous 1D inversion results can provide 2D geological structures as the 2D visualization 420. The 1D inversion 410 is shown to be homogenous in the East direction to simplify the determination of the 2D visualization. Thus, resultant continuous data 2D visualization 420 provides up-down (vertical depth) information, e.g., to assist a geosteering decision, but provides no left-right (horizontal) information because of the assumed homogenous nature in the 1D inversion 410.

However, as homogeneity is likely not accurate in most cases, a 1D inversion can alternatively account for a relative bed azimuth angle, wherein the relative bed azimuth angle is defined by an angle between a tool high side direction and a direction with the shortest distance to surrounding bed boundaries. When the 1D inversion accounts for the relative bed azimuth angle, each local 1D inversion at a particular depth could rotate at, or orient towards, different a different azimuth angle to provide non-homogeneous information over an accumulated depth profile, where an accumulated depth profile is a section of contiguous, i.e., accumulated, point-by-point 1D inversions.

In another example, FIG. 4B depicts two three-dimensional (3D) visualizations of the inversion results, according to one or more embodiments. The 3D visualization 430 of the inversion results is depicted mapped in a TVD-North-East plane. The 3D visualization 440 shows the same inversion results also mapped to a TVD-North-East plane but rotated to get a better perspective view of the three-dimensionality of the inversion results. In one or more embodiments, the 3D visualization is based on 1D inversion results and relative bed azimuth angles at various depths, e.g., based on interpolation of continuous and accumulated 1D inversion results with the relative bed azimuth angles at each depth.

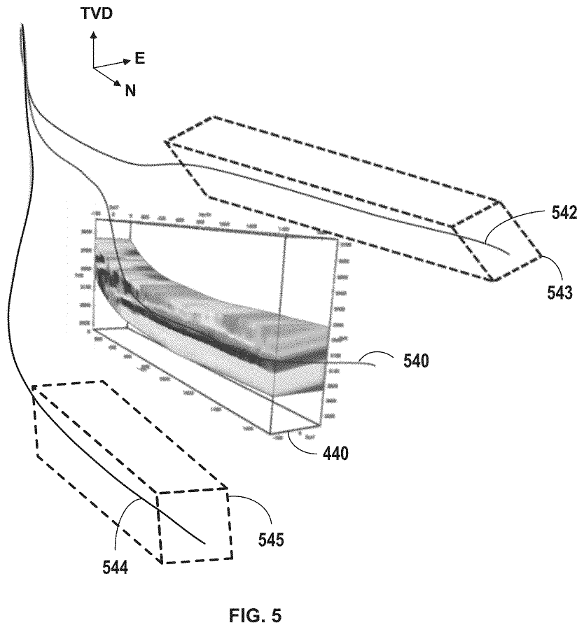

FIG. 5 depicts the two or more wellbores (three wellbores 540, 542, and 544 are shown) having inversion results acquired for each wellbore, according to one or more embodiments. The one or more wellbores are depicted as oriented in a TVD-N-E plane, but each of the inversion results are depicted as being locally oriented along the wellbore, e.g., along the measured depth of each wellbore. The two or more wellbores can be disposed in the same formation, e.g., drilled from the same pad. In one or more embodiments, the wellbores can be separated by a distance of less than or equal to 300 m, less than or equal to 250 m, less than or equal to 200 m, less than or equal to 150 m, or less than or equal to 100 m.

A first wellbore 540 is depicted as having the 3D visualization 440 oriented along measured depth from FIG. 4. Likewise, a 3D outline of second inversion result 543 are shown along a second wellbore 542 and a 3D outline of third inversion results 545 are shown along a third wellbore 544. The 3D outlines of the second inversions results 543, the third inversions results 545, and the textured 3D shape in 540 depict the defined range discussed above. Note, while these are shown as being rectangular, the defined range could also be depicted circularly, i.e., as cylinder, or some other polyhedron. While a 3D image is shown, the inversion results could be visualized as 1D, 2D, or 3D image(s).

The defined range (i.e. the detection range) is determined by the DOI of system (e.g., systems 100 or 200) disposed in each wellbore. For example, the DOI can be as far as about 100 ft (about 30 m), about 200 ft (about 61 m), about 300 ft (about 91 m), or about 400 ft (about 122 m), or about 500 ft (about 152 m). As such, the defined range can range from 0 to 500 ft (from 0 to about 152 m) for each wellbore. For example, in one or more embodiments the defined range can be from 10 ft to 300 ft. This defined range can extend azimuthally around the wellbore and is measured radially from the wellbore, i.e., the maximum extent of the defined range is a radius equal to the maximum distance of the DOI.

Referring again to FIG. 3, at 310, the inversion results acquired from the two or more wellbores are transformed into first 3D mesh properties. A 3D mesh can be made up of a mesh, which is a basic unit to define an overall image. For example, a 3D mesh can be polygon mesh that is a collection of vertices, edges, faces, polygons, and/surfaces that define a shape of a polyhedral object or can be a volumetric mesh representing an interior volume of an object, e.g., discretizing an interior structure of an object. 3D mesh properties are one or more property or attribute represented as a 3D mesh. In one or more embodiments, 3D mesh properties can be formed from an accumulation of 2D properties. The first 3D mesh properties represent one or more geological features of the subterranean formation 105 surrounding each wellbore of the two or more wellbores within a defined range from each of the wellbores, where the one or more geological features are correlated to a 3D coordinate system. In one or more embodiments, the one or more geological features include at least one of resistivity, permeability, porosity, conductivity, permittivity, or the like. For example, the first 3D mesh properties can represent one or more resistivity values and geological boundaries mapped to 3D space. In one or more embodiments, each 3D mesh is a pixel. The pixel can be big or small, with the pixel size being defined based on a desired resolution. The pixel can be square, rectangular, triangular, circular, hexagonal, octagonal, or other polygon shape. The mesh can be made up of a grid with multiple faces, each face being the pixel shape. The accumulation of all the mesh or pixels becomes a 3D mesh. Each mesh unit or pixel can have a single color or grayscale value representing a value of a geological feature.

In one or more embodiments, other sources can be combined with the inversion results to acquire the first 3D mesh properties. For example, data from one or more offset logs or from different types of well logging tools can be combined with the inversion results to acquire the first 3D mesh properties. Including data from other sources can, in some cases, improve the accuracy of the first 3D mesh properties.

In one or more embodiments, the inversion results are transformed into the first 3D mesh properties by applying one or more 3D linear or non-linear interpolation methods to continuous and adjacent 1D inversion results based on a local coordinate system for each 1D inversion result to provide structure (or shape) and correlation of the one or more geological features in 3D spaces. For example, inversion results of resistivity measurements can be transformed in a 3D mapping of resistivity in the subterranean formation 105 within the defined range of each individual wellbore (which can be visualized as a 3D visualization as shown in FIG. 4).

At 312, one or more machine learning algorithm is used to determine one or more characteristic geological features among the two or more wellbores based on the defined one or more geological features. The characteristic geological features can be similar geological features, e.g. similar formation profiles or similar formation resistivity contrast, between layers among the two or more wellbores within a TVD range. Another embodiment of the characteristic geological features can be dissimilarity formation profiles among the two or more wellbores within a TVD range. For example, at a first wellbore there can be high resistivity formations indicating a reservoir within a particular TVD range, whereas a second wellbore within the same TVD range may contain both high resistivity formations indicating the reservoir and also a small portion of low resistivity formations indicating a water zone, e.g. a water zone created by water injection from the second wellbore during the production. Indication of the dissimilarity for the water zone between the first and the second wellbore can help interpolation of how one or more water zones propagates from the second wellbore into the first wellbore. In one or more embodiments, the one or more machine learning algorithm can learn from images of the inversion results (1D, 2D, or 3D) and determine differences and/or similarities between the results. For example, one or more clustering algorithm (e.g., k-Means, k-medians, Expectation Maximization, Hierarchical Clustering, or the like), instance-based algorithm (e.g., k-Nearest Neighbor (KNN), Learning Vector Quantization (LVQ), Self-Organizing Map (SOM), Locally Weighted Learning (LWL), Support Vector Machines (SVM), or the like), Bayesian algorithms (e.g., Naive Bayes, Gaussian Naive Bayes, Multinomial Naive Bayes, Averaged One-Dependence Estimators (AODE), Bayesian Belief Network (BBN), Bayesian Network (BN), or the like), artificial neural network algorithms (Perceptron, Multilayer Perceptrons (MLP), Back-Propagation, Stochastic Gradient Descent, Hopfield Network, Radial Basis Function Network (RBFN), or the like), deep learning algorithms (Convolutional Neural Network (CNN), Recurrent Neural Networks (RNNs), Long Short-Term Memory Networks (LSTMs), Stacked Auto-Encoders, Deep Boltzmann Machine (DBM), Deep Belief Networks (DBN), or the like), or a combination thereof, can be used to determine characteristic geological features among the two or more wellbores. In one or more embodiments, the one or more machine learning algorithms are used to determine locations and profiles of characteristic geological features among the two or more wellbores.

In one or more embodiments, machine learning may be utilized to identify or define the geological features and identify the similarities and differences among the geological features, i.e., formation geologies, geological boundaries, and/or geology information, as well as to train the information handling system 120 (e.g., referring to FIGS. 1 and 2) to recognize a model that may fit the characteristic geological features. For example, recalculating similarities among all inverted results using different ranges may train the information handling system 120 to identify the best model or a reliable model. A guide-model inversion can be implemented to further train the information handling system 120 to recognize a model that may fit the characteristic geological features.

In one or more embodiments, the one or more machine learning algorithms can score, i.e., grade, identified (i.e., defined) geological features to determine similarities, differences and/or correlation between the geological features. For example, features with higher scores can indicate features with more similarity and features with lower scores can indicate features with less similarity. The similarities can be weighted based on score, similarity, and/or distance between wellbores, e.g., geological similarities between closer points of two or more wellbores can be given more weight. In one or more embodiments, a geological feature is similar to another geological feature when a unit to measure the geological feature is the same or within the same range. For example, when the geological feature is resistivity, the geological features can be deemed similar if they have the same resistivity value measured in Ω-m or a resistivity value within a chosen range of resistivity. This, of course, applies to other geological features besides resistivity.

At 314, second 3D mesh properties are interpolated based on the one or more geological features. The second 3D mesh properties are properties of the formation outside the defined range. In one or more embodiments, the second 3D mesh properties are properties of the formation between the two or more wellbores and outside the defined range.

In one or more embodiments, interpolation of the second 3D mesh properties is accomplished by selecting one or more transforms and interpolating the second 3D mesh properties using the selected transforms and the one or more characteristic geological features. The one or more transforms used for interpolation can be non-linear or linear functions. For example, the one or more transforms can be one or more linear functions to provide linear interpolation, one or more polynomial functions to provide polynomial interpolation, and/or one or more spline functions to provide spline interpolation. The one or more transforms can also, or alternatively, include trigonometric polynomial functions to provide trigonometric interpolation, e.g., cosine function and/or sin functions. Other interpolation can be used such as ration interpolation or multivariate interpolation (e.g., bilinear interpolation, bicubic interpolation, trilinear interpolation, or the like). Different transforms, functions, and/or types of interpolation can be used for different points, for different depths, or even among different wellbores.

In one or more embodiments, the one or more transforms can be selected based on the transform's fit to the characteristic geological features among the two or more wellbores. For example, an algorithm, e.g., a machine learning algorithm, or other processing can estimate or try one or more transforms from a set of transforms (see types above), e.g., by comparing a fit of each transforms to the one or more characteristic geological features, and determine a best fit “link function” that can be applied for a particular set of two or more wellbores and select that function for use in the interpolation at one or more depth and/or location. The more wellbores in the formation, e.g., wellbores drilled from the same pad, the more accurately a transform can be selected based on fit to the characteristic geological features in one or more wellbore. For example, with three or more wellbores, a function can be applied to characteristic geological features between a first wellbore and a second wellbore and then the function can be compared with characteristic features of a third wellbore, i.e., to determine how closely the function fits, and then the function with the best fit between the three well bores for that characteristic geological feature can be selected and used for interpolation for that location or for other locations. In one or more embodiments, best fit is estimated based on an amplitude and/or angle of the 3D mesh properties. For example, the machine learning algorithm can take an angle, amplitude, slope, or other shape feature of the 3D mesh properties as an input for determining the best fit transform.

In one or more embodiments, initial assumptions of a geological model (e.g., from seismic or other sources) can also be used as an input to machine learning to determine the best function to be used for interpolation. For example, machine learning can further improve selection of the one or more transforms based on a database from previous wellbores and/or pads. Further inputs such as new geological data, e.g., data from LWD, MWD, or other logging, obtained later in time than the inversion results from the initial measurements can also be input into machine learning to improve selection of the one or more transforms. For example, new information and/or geological data from wellbores and/or pads in one or more similar location can be input into machine learning to improve selection of the one or more transforms.

In one or more embodiments, the selected transforms functions are used to interpolate, i.e., link, the characteristic geological features between or among at least two wellbores, i.e., “filling in” areas of the formation between the two or more wellbores outside the defined range of each wellbore.

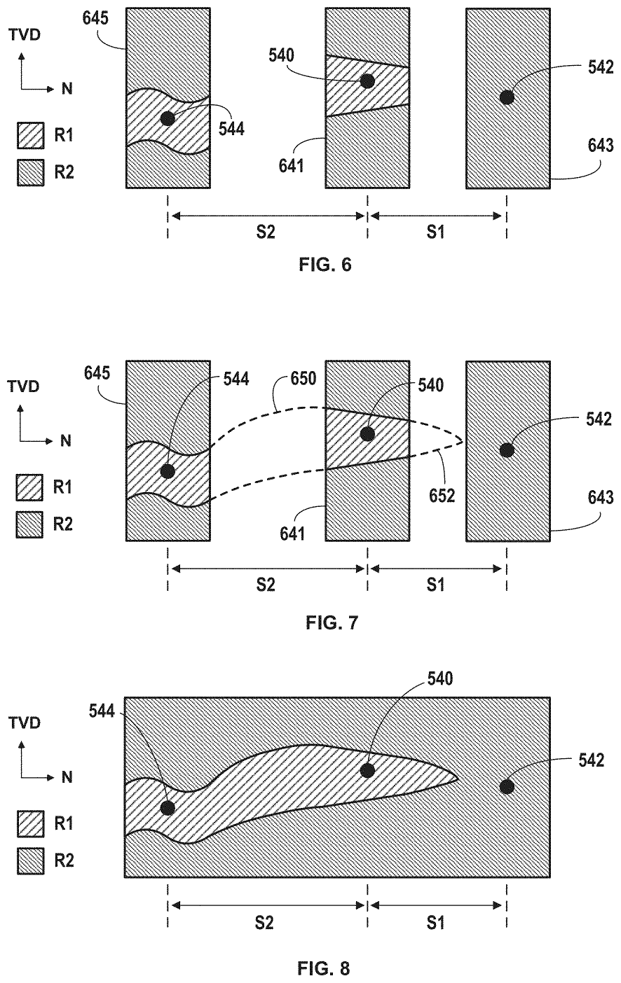

FIG. 6 depicts a 2D cross-plane visualization for the inversion results in a TVD-North plane for the two or more wellbores (three wellbores 540, 542, and 544 are shown), according to one or more embodiments. (A 2D cross-plane visualization is not required but can provide a clear picture of the process and can be implemented in one or more embodiments.) The 2D cross-plane visualization depicts a 2D image, or “slice”, of the inversion results for each wellbore at a particular location along each wellbore. This particular location along the wellbore can be a particular measured depth along at least one of the wellbores, but not necessarily be the same measured depth for all of the two or more wellbores. Indeed, such 2D cross-plane visualization of the inversion results can be obtained for a multiplicity of locations and combinations of locations along each wellbore. Further, while three wellbores are depicted the process could be applied with only two wellbores or with more than three wellbores.

The 2D slices shown represent a 2D image of the first 3D mesh properties for each wellbore, i.e., the “box” of each 2D slice demarks the defined range of the inversion results in the TVD-North plane. As shown, a first box depicts to a first 2D slice 641 of the inversion results at a first location along the first wellbore 540. Likewise, a second box depicts a second 2D slice 643 at a second location along the second wellbore 542, and a third box depicts a third 2D slice 645 at a third location along the second wellbore 544. The different hatching depicted indicate characteristic geological features across inversion results. For example, both the first 2D slice 641 and the third 2D slice 645 are depicted have a first characteristic geological feature R1, e.g., a similar resistivity, that is not present in the second 2D slice 643, while all the 2D slices are shown to possess the second characteristic geological feature R2. Although only two characteristic geological features are depicted, a two or more characteristic geological features can be identified by the machine learning algorithm.

The first wellbore 540 is separated in a “North” vector direction from the second wellbore 542 by distance S1 and from the third wellbore 544 by distance S2. In one or more embodiments, the distance between the respective wellbores is used by the machine learning algorithm in determining characteristic geological features. For example, features with a closer distance between them can be given a greater weight than features further apart, as those closer together are more likely to be similar.

FIG. 7 depicts the 2D cross-plane visualization of the inversion results with one or more interpolation results between the two or more wellbores, according to one or more embodiments. For example, as shown, the interpolation with the one or more transforms produces a first interpolation result 650 and a second interpolation result 652. The interpolation results fit the shape of a characteristic geological feature in first wellbore to the same characteristic geological feature in the second well. Said differently, the characteristic geological features are linked among the two or more wellbores based on the selected one or more transforms. For example, as depicted the shape of the first characteristic geological feature R1 in the first slice 641 can be used to fit with the one or more transforms (in any one of the ways described above) to the shape the first characteristic geological features R1 in the second slice 643, i.e., the transforms link the first characteristic features together. Note, while this is shown as being performed with a visualization to better understanding of the method, the interpolation can be done without visualizing the process.

The interpolation results in the second 3D mesh properties between the two or more wellbores. For example, in the TVD-North plane depicted, the space between the wellbores and outside the defined range, i.e., outside the boundary of the box demarking the 2D slices, can be filled in using the interpolation results to form the second 3D mesh properties.

Referring again to FIG. 3, at 316, the first 3D mesh properties and the second 3D mesh properties can be integrated to acquire final 3D mesh properties. Once the second 3D mesh properties are determined via interpolation, the first 3D mesh properties and the second 3D mesh properties can be integrated to obtain final 3D mesh properties. The integration can be done via a processor, e.g., using the information handling system. The final 3D mesh properties can be visualized using a 3D reservoir model, e.g., a 3D earth model, and/or using multiple 2D visualizations, such as multiple 2D cross-plane visualizations. A 3D reservoir model is computer model of a subsurface reservoir have a 3D relationship between one or more geological properties, i.e., representing a physical spatial relationship of the reservoir by one or more arrays, grids, cells, and/or meshes in three dimensions.

FIG. 8 depicts a 2D cross-plane visualization of integrated inversion results among the two or more wellbores, according to one or more embodiments. As depicted, the interpolation between the inversion results of the three wellbores 540, 542, 544 been formed into the second 3D mesh properties, shown in 2D along the TVD-N plane, and then integrated with the first 3D mesh properties to form 2D cross-plan visualization of the 3D mesh properties.

As will be understood, while the examples above are carried out for three wellbores and a single location (i.e., measured depth) along each of the wellbores, this same process can be carried out for multiple measured depths along each wellbore. Further, while the interpolation was shown in a 2D plane, the interpolation could be done in three dimensions, e.g., using cube interpolation and or by performing multiple 2D interpolations in varying planes and across varying locations. In one or more embodiments, a later interpolation, e.g., performed using different points along one or more wellbore and/or across a different plane angle can be used to correct earlier interpolations.

In one or more embodiments, one or more wellbore operation can be performed based on the final 3D mesh properties. The one or more wellbore operation can include, without limitation, one or more of production enhancement (e.g., hydraulic fracturing), cementing, drilling a new wellbore, directional drilling (e.g., geosteering), measurement while drilling, logging while drilling, a wireline service (e.g., logging), coiled tubing service, hydraulic workover service, reporting or recording measurements (e.g. those acquired downhole), geological or petrophysical interpretation, lowering or raising a tool in the wellbore, actuating a downhole tool or device (e.g. a sensor, valve, screen, sleeve, etc.), or the like.

FIG. 3 is annotated with a series of numbers 302 to 216. These numbers represent stages of operations. Although these stages are ordered for this example, the stages illustrate one example to aid in understanding this disclosure and should not be used to limit the claims. Subject matter falling within the scope of the claims can vary with respect to the order and some of the operations. The flowchart in FIG. 3 is provided to aid in understanding the illustrations and is not to be used to limit scope of the claims. The flowchart depicts example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code and/or instructions stored in one or more computer-readable storage media (such as non-transitory computer-readable media 128). Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure. Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### EXAMPLE EMBODIMENTS

Numerous examples are provided herein to enhance understanding of the present disclosure. A specific set of example embodiments are provided as follows:

Example A: A method comprising acquiring inversion results from two or more wellbores; transforming the inversion results into first 3D mesh properties, wherein the first 3D mesh properties represent one or more geological features of a formation surrounding each wellbore of the two or more wellbores within a defined range from each of the wellbores, where the one or more geological features are correlated to a 3D coordinate system; determining, using a machine learning algorithm, one or more characteristic geological features among the two or more wellbores based on the first 3D mesh properties; interpolating second 3D mesh properties based on the one or more characteristic geological features, wherein the second 3D mesh properties are properties of the formation outside the defined range; and integrating the first 3D mesh properties and the second 3D mesh properties to acquire final 3D mesh properties, and, optionally, wherein at least one of the following (in any order): (i) the one or more wellbores are drilled from a same pad; (ii) the inversion results are continuous and adjacent 1D inversion results; or (iii) the second 3D mesh properties are properties of the formation between the two or more wellbores and outside the defined range.

The method in Example A can further comprise one or more of the following (in any order): (1) disposing one or more downhole tools into at least one wellbore of the two or more wellbores, taking one or more measurements of the formation with the one or more downhole tools, and generating the inversion results based on the one or more measurements, and, optionally wherein at least one of the following (in any order): (a) taking the one or more measurements of the formation comprises taking one or more electromagnetic measurements; (b) wherein the one or more electromagnetic measurements are continuous and adjacent; (2) providing a 2D cross-plane visualization of at least one of the first 3D mesh properties, the second 3D mesh properties, and the final 3D mesh properties; (3) performing a wellbore operation based on the final 3D mesh properties; or (4) visualizing the final 3D mesh properties as a 3D reservoir model. In one or more embodiments of Example A interpolating the second 3D mesh properties comprises at least one of the following (in any order): (I) selecting one or more transform, and interpolating the second 3D mesh properties using the one or more selected transform and the one or more characteristic geological features; or (II) comparing a fit of each transform of a set of transforms to the one or more characteristic geological features, selecting a transform from the set of transforms that has a best fit, and interpolating the second 3D mesh properties using the selected transform and the one or more characteristic geological features.

Example B: A system comprising two or more wellbores; one or more downhole tools disposable in at least one wellbore of the two or more wellbores; a processor; and a computer-readable storage medium having program code executable by the processor to cause the processor to acquire inversion results from the two or more wellbores; transform the inversion results into first 3D mesh properties, wherein the first 3D mesh properties represent one or more geological features of a formation surrounding each wellbore of the two or more wellbores within a defined range from each of the wellbores, where the one or more geological features are correlated to a 3D coordinate system; determine, using a machine learning algorithm, one or more characteristic geological features among the two or more wellbores based on the first 3D mesh properties; interpolate second 3D mesh properties based on the one or more characteristic geological features, wherein the second 3D mesh properties are properties of the formation outside the defined range; and integrate the first 3D mesh properties and the second 3D mesh properties to acquire final 3D mesh properties.

In one or more embodiments of Example B, the one or more downhole tools are disposed in at least one wellbore of the two or more wellbores; the computer-readable storage medium has further program code executable by the processor to cause the one or more downhole tools to take one or more measurements of the formation; and the computer-readable storage medium has further program code executable by the processor to cause the processor to generate the inversion results based on the one or more measurements, and, optionally, (i) the one or more downhole tools comprise at least one transmitter and at least one receiver, wherein taking the one or more measurements of the formation comprises taking one or more electromagnetic measurements using the at least one transmitter and the at least one receiver, and/or (ii) the one or more wellbores are drilled from a same pad.

Example C: One or more non-transitory computer-readable storage media comprising program code to: acquire inversion results from two or more wellbores; transform the inversion results into first 3D mesh properties, wherein the first 3D mesh properties represent one or more geological features of a formation surrounding each wellbore of the two or more wellbores within a defined range from each of the wellbores, where the one or more geological features are correlated to a 3D coordinate system; determine, using a machine learning algorithm, one or more characteristic geological features among the two or more wellbores based on the first 3D mesh properties; interpolate second 3D mesh properties based on the one or more characteristic geological features, wherein the second 3D mesh properties are properties of the formation outside the defined range; and integrate the first 3D mesh properties and the second 3D mesh properties to acquire final 3D mesh properties.

In one or more embodiments of Example C the computer-readable storage media further comprises program code to generate the inversion results based on one or more measurements the formation taken with one or more downhole tools disposed into at least one wellbore of the two or more wellbores; and visualize the final 3D mesh properties as a 3D reservoir model. In one or more embodiments of Example C interpolating the second 3D mesh properties comprises at least one of the following (in any order): (I) selecting one or more transform, and interpolating the second 3D mesh properties using the one or more selected transform and the one or more characteristic geological features; or (II) comparing a fit of each transform of a set of transforms to the one or more characteristic geological features, selecting a transform from the set of transforms that has a best fit, and interpolating the second 3D mesh properties using the selected transform and the one or more characteristic geological features.

What is claimed is:

1. A method comprising:
acquiring inversion results from two or more wellbores;
transforming the inversion results into first 3D mesh properties, wherein the first 3D mesh properties represent one or more geological features of a formation surrounding each wellbore of the two or more wellbores within a defined range from each of the wellbores, where the one or more geological features are correlated to a 3D coordinate system;
determining, using a machine learning algorithm, one or more characteristic geological features among the two or more wellbores based on the first 3D mesh properties;
interpolating second 3D mesh properties based on the one or more characteristic geological features, wherein the second 3D mesh properties are properties of the formation outside the defined range; and
integrating the first 3D mesh properties and the second 3D mesh properties to acquire final 3D mesh properties.

2. The method of claim 1 further comprising:
disposing one or more downhole tools into at least one wellbore of the two or more wellbores;
taking one or more measurements of the formation with the one or more downhole tools; and
generating the inversion results based on the one or more measurements.

3. The method of claim 2, wherein taking the one or more measurements of the formation comprises taking one or more electromagnetic measurements.

4. The method of claim 3, wherein the one or more electromagnetic measurements are continuous and adjacent.

5. The method of claim 1, further comprising providing a 2D cross-plane visualization of at least one of the first 3D mesh properties, the second 3D mesh properties, and the final 3D mesh properties.

6. The method of claim 1, wherein the one or more wellbores are drilled from a same pad.

7. The method of claim 1, further comprising performing a wellbore operation based on the final 3D mesh properties.

8. The method of claim 1, further comprising visualizing the final 3D mesh properties as a 3D reservoir model.

9. The method of claim 1, wherein the inversion results are continuous and adjacent 1D inversion results.

10. The method of claim 1, wherein interpolating the second 3D mesh properties comprises:
selecting one or more transform; and
interpolating the second 3D mesh properties using the one or more selected transform and the one or more characteristic geological features.

11. The method of claim 1, wherein interpolating the second 3D mesh properties comprises:
comparing a fit of each transform of a set of transforms to the one or more characteristic geological features;
selecting a transform from the set of transforms that has a best fit; and
interpolating the second 3D mesh properties using the selected transform and the one or more characteristic geological features.

12. The method of claim 1, wherein the second 3D mesh properties are properties of the formation between the two or more wellbores and outside the defined range.

13. A system comprising:
two or more wellbores;
one or more downhole tools disposable in at least one wellbore of the two or more wellbores;
a processor; and
a computer-readable storage medium having program code executable by the processor to cause the processor to
acquire inversion results from the two or more wellbores;
transform the inversion results into first 3D mesh properties, wherein the first 3D mesh properties represent one or more geological features of a formation surrounding each wellbore of the two or more wellbores within a defined range from each of the wellbores, where the one or more geological features are correlated to a 3D coordinate system;
determine, using a machine learning algorithm, one or more characteristic geological features among the two or more wellbores based on the first 3D mesh properties;
interpolate second 3D mesh properties based on the one or more characteristic geological features, wherein the second 3D mesh properties are properties of the formation outside the defined range; and
integrate the first 3D mesh properties and the second 3D mesh properties to acquire final 3D mesh properties.

14. The system of claim 13, wherein the one or more downhole tools are disposed in at least one wellbore of the two or more wellbores;
wherein the computer-readable storage medium has further program code executable by the processor to cause the one or more downhole tools to take one or more measurements of the formation; and
wherein the computer-readable storage medium has further program code executable by the processor to cause the processor to generate the inversion results based on the one or more measurements.

15. The system of claim 14, wherein the one or more downhole tools comprise at least one transmitter and at least one receiver; and
wherein taking the one or more measurements of the formation comprises taking one or more electromagnetic measurements using the at least one transmitter and the at least one receiver.

16. The system of claim 14, wherein the one or more wellbores are drilled from a same pad.

17. One or more non-transitory computer-readable storage media comprising program code to:
acquire inversion results from two or more wellbores;
transform the inversion results into first 3D mesh properties, wherein the first 3D mesh properties represent one or more geological features of a formation surrounding each wellbore of the two or more wellbores within a defined range from each of the wellbores, where the one or more geological features are correlated to a 3D coordinate system;
determine, using a machine learning algorithm, one or more characteristic geological features among the two or more wellbores based on the first 3D mesh properties;
interpolate second 3D mesh properties based on the one or more characteristic geological features, wherein the second 3D mesh properties are properties of the formation outside the defined range; and
integrate the first 3D mesh properties and the second 3D mesh properties to acquire final 3D mesh properties.

18. The computer-readable storage media of claim 17, further comprising program code to:
generate the inversion results based on one or more measurements the formation taken with one or more downhole tools disposed into at least one wellbore of the two or more wellbores; and
visualize the final 3D mesh properties as a 3D reservoir model.

19. The computer-readable storage media of claim 17, wherein interpolating the second 3D mesh properties comprises:
selecting one or more transform; and
interpolating the second 3D mesh properties using the one or more selected transform and the one or more characteristic geological features.

20. The computer-readable storage media of claim 17, wherein interpolating the second 3D mesh properties comprises:
comparing a fit of each transform of a set of transforms to the one or more characteristic geological features;
selecting a transform from the set of transforms that has a best fit; and
interpolating the second 3D mesh properties using the selected transform and the one or more characteristic geological features.
